(19) United States
(12) Patent Application Publication
(10) Pub. No.: US 2014/0054829 A1
(43) Pub. Date: Feb. 27, 2014

(54) CONTAINER WITH END FEATURE AND METHOD OF MAKING SAME

(71) Applicant: Anthony L. Poo, Biscayne Park, FL (US)

(72) Inventor: Anthony L. Poo, Biscayne Park, FL (US)

(73) Assignee: ALTIRA, INC., Miami, FL (US)

(21) Appl. No.: 13/591,505

(22) Filed: Aug. 22, 2012

(51) Int. Cl. B29C 49/00; B29C 45/26; B32B 1/02; B29C 49/48

(52) U.S. Cl. 264/533; 425/525; 425/542; 425/533; 428/35.7; 428/36.9

(57) ABSTRACT

A method of making a container includes the step of providing a preform having a body defining an interior cavity. The body has an end portion and an end feature protruding from the end portion. The preform is placed into a mold. The mold has a mold cavity for receiving the preform body and a feature cavity for receiving the end feature. A stretch rod is inserted into the interior cavity of the preform to a position adjacent the end feature, whereby the stretch rod will retain the end feature in the feature cavity. The preform is blow molded into a finished product. The stretch rod retains the end feature in the feature cavity during the blow molding step.

### FIELD OF THE INVENTION

This invention relates to blow molding, and more particularly to blow molding containers with three dimensional features.

### BACKGROUND OF THE INVENTION

Blow molding is a common method of forming containers. The blow molding process typically utilizes a preform. The preform is a precursor of the finished container. The preform is usually much smaller than the container and can be formed by another process such as injection molding. The preform is a tube-like piece of plastic having a hole or open end into which compressed air can be injected. The preform is inserted into the blow molding cavity and secured in position. The mold is closed to be airtight and compressed air is blown into the open end of the preform. The sides of the preform are expanded by the compressed air and forced against the mold surfaces. The plastic of the preform takes the shape of the mold to form a desired finished product. As the preform is expanded in all directions by the gas pressure to the blow mold surfaces, the thickness of the plastic material is relatively constant. Blow molding typically cannot be used to form three dimensional features that require an excess or non-uniform amount of plastic material or which have high aspect ratios. Containers with such features typically must be formed by injection molding, which also has limitations. Also, deep-set features are difficult to form because the material has difficulty coating deep-set mold surfaces during the blow molding process.

### SUMMARY OF THE INVENTION

A method of making a container includes the step of providing a preform having a body defining an interior cavity. The body has an end portion and an end feature protruding from the end portion. The preform is placed into a mold. The mold has a mold cavity for receiving the preform body and a feature cavity for receiving the end feature. A stretch rod is inserted into the interior cavity of the preform to a position adjacent the end feature, whereby the stretch rod will retain the end feature in the feature cavity. The preform is blow molded into a finished product. The stretch rod retains the end feature in the feature cavity during the blow molding step. The end feature remains unchanged during the blow molding step.

The mold can comprise a rim about the feature cavity. The stretch rod can be extended to a position abutting a portion of the preform between the stretch rod and the rim to retain the feature in the feature cavity during the blow molding step. The stretch rod and the mold define an annular gap for receiving a corresponding portion of the preform. The stretch rod can be extended to a position no closer to the mold than the thickness of the preform between the stretch rod and the mold.

The providing step can include molding the preform. The molding of the preform can include forming an opening in the end feature. The forming of an opening can comprise inserting a pin during the molding of the preform to form the opening, and removing the pin prior to removal of preform from preform mold. The preform can be molded by an injection molding process.

An apparatus for making a container from a preform having an end feature includes a blow mold. The blow mold defines a main mold cavity and a feature cavity. A stretch rod is provided for inserting into the main mold cavity to a position adjacent the feature cavity, whereby the stretch rod will retain the end feature of the preform in the feature cavity during a blow molding step.

The stretch rod can have a retracted position and an extended position. The stretch rod in the extended position extends into the mold cavity to a position where a tip portion of the stretch rod is adjacent the feature cavity, and in a retracted position the stretch rod is withdrawn from the mold cavity.

An apparatus for making a preform includes an injection mold having a body mold portion for molding a preform having an end portion. An end feature mold portion is provided for molding an end feature of the preform at an end portion. An injection cavity pin can be provided for forming an opening in the end feature during the molding of the end feature. A drive mechanism can extend and retract the pin.

A preform for making a plastic container has a preform body having an end portion. An end feature is provided at the end portion. The end feature protrudes from the end portion. The end feature can have at least one opening.

A system for forming a container includes an apparatus for making a preform with an end feature. The apparatus has an injection mold with a body mold portion for molding a preform body portion having an end portion. An end feature mold portion is provided for molding an end feature of the preform at an end portion. An apparatus for making a container from the preform having an end feature includes a blow mold. The blow mold defines a main mold cavity and a feature cavity. A stretch rod is provided for inserting into the main mold cavity to a position adjacent the feature cavity, whereby the stretch rod will retain the end feature of the preform in the feature cavity during a blow molding step.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a side elevation of a preform according to a first embodiment.

FIG. 2 is a cross-section.

FIG. 3 A-C is a magnified side elevation of an end feature according to a A) first embodiment; B) second embodiment; and 3) third embodiment.

FIG. 4 A-D is a cross section of an apparatus for molding a preform in A) a first stage of operation; B) a second stage of operation; C) a third stage of operation; and D) a fourth stage of operation.

FIG. 5 A-C is a side elevation of a preform trimming operation in A) a first stage of operation; B) a second stage of operation; and C) a third stage of operation.

FIG. 6 A-E is a cross-section of a blow molding apparatus according to the invention in A) a first stage of operation; B) a second stage of operation; C) a third stage of operation; D) a fourth stage of operation; and E) a fifth stage of operation.

### DETAILED DESCRIPTION OF THE INVENTION

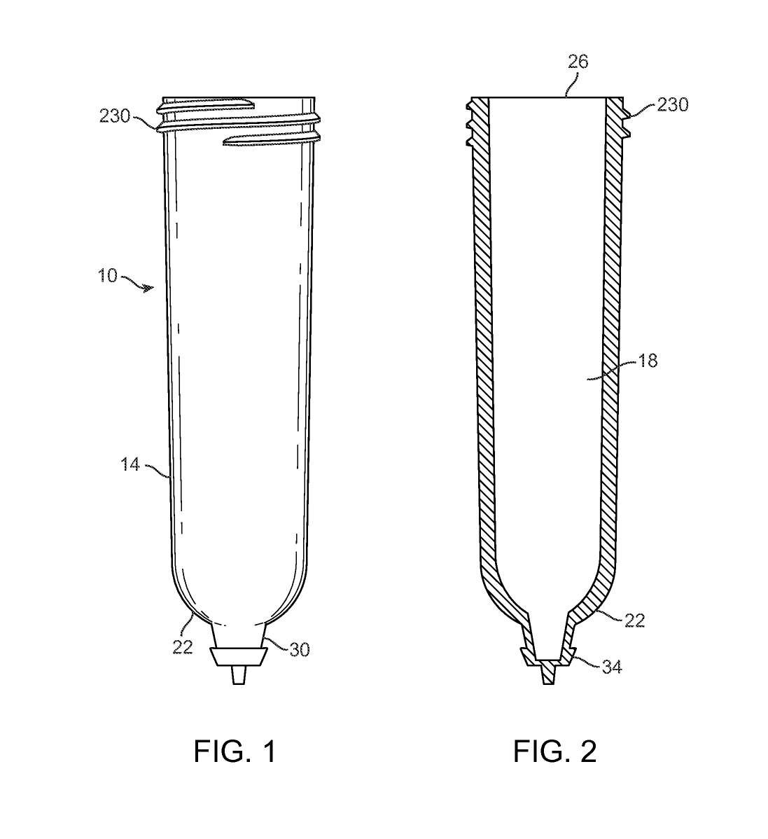

A preform 10 is shown in FIGS. 1-2. The preform 10 can take many different sizes and shapes but generally has an elongated tubular body 14 defining an open interior cavity 18. The body 14 has a distal end portion 22 and an open end 26. The distal end portion 22 can be closed and can be provided with a feature 30. The feature 30 can in one embodiment be in the form of a spout 34 for use in dispensing liquids from the finished container that is made from the preform 10.

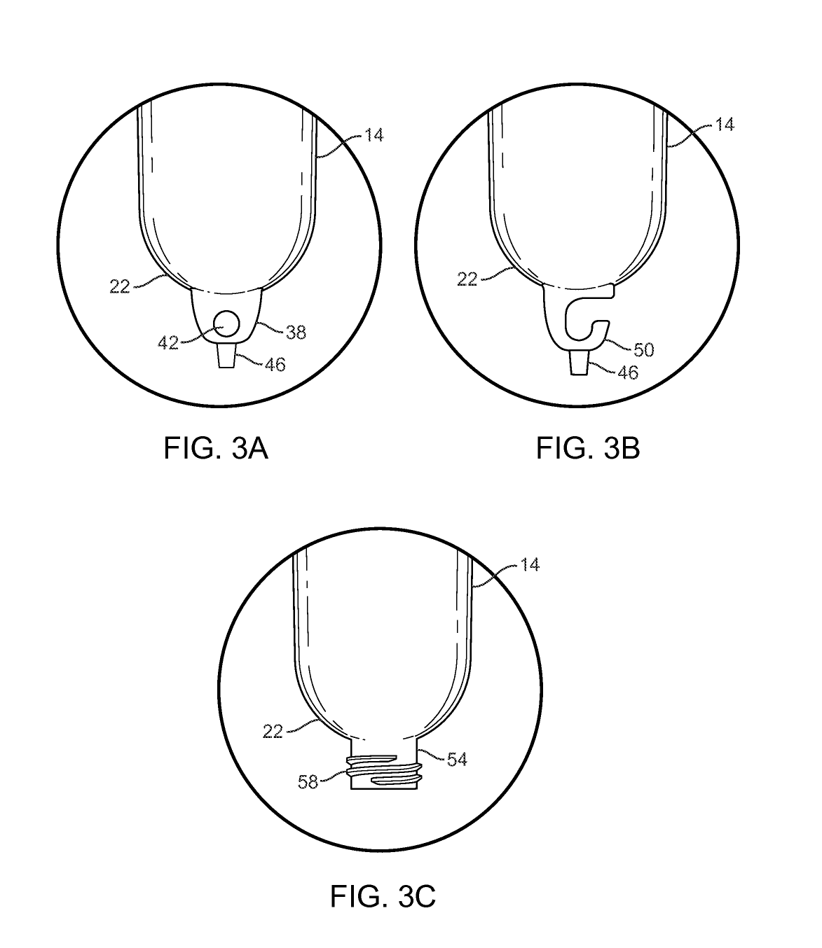

The end feature can take many different sizes, shapes and designs. The end feature can be a tab 38 having an aperture 42 for hanging the finished container, shown in FIG. 3A. A runner 46 is typically formed during the injection molding process and can be removed in a subsequent trimming step. The end feature can be a hook 50 for hanging the finished container, as shown in FIG. 3B. The end feature can be an open neck 54 for dispensing liquids or other contents from the finished container, and for securing a cap to the finished container. Suitable engagement structure such as the threads 58 can be molded into the neck 54 for this purpose.

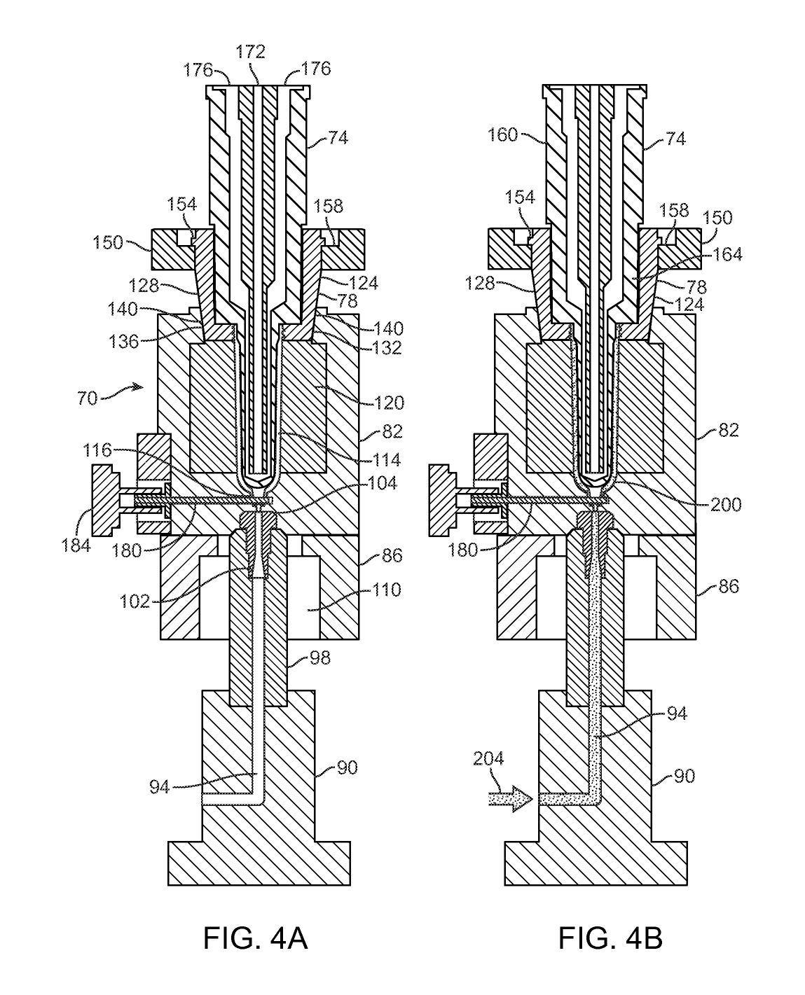

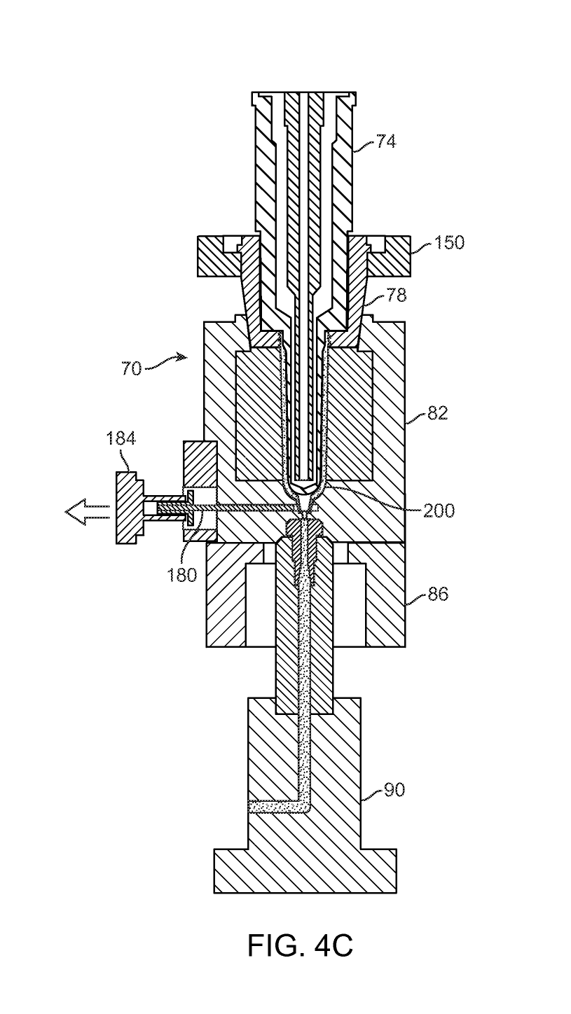

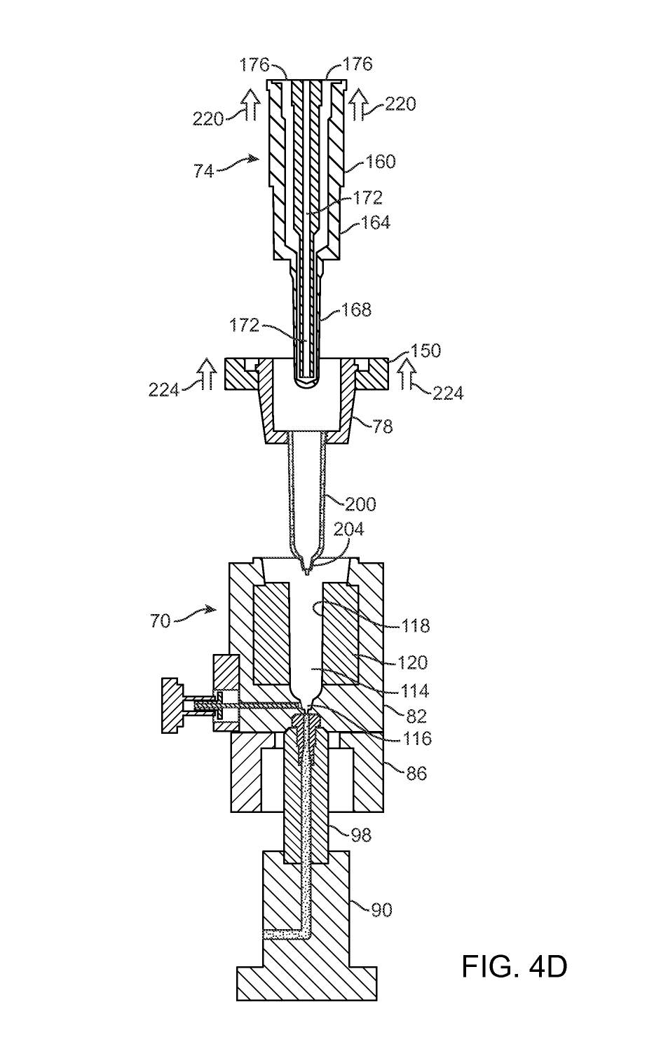

The preform 10 can be molded by any suitable process and apparatus, for example, molding apparatus 70, as shown in FIGS. 4A-D. The preform molding apparatus 70 can include an injection core 74, a neck split 78, an injection block 82, a spacer block 86, and a single cavity manifold 90. The single cavity manifold 90 has a conduit 94 for conducting plastic precursor through a first nozzle 98, a second nozzle 102, and a third nozzle 104. The spacer block 86 includes an opening 110 for receiving the first nozzle 98. The fluid conduit 94 extends through the single cavity manifold 90, the first nozzle 98, second nozzle 102, and third nozzle 104, and communicates with a preform mold cavity 114 that is defined by a surface 118 in the injection block 82. The preform mold cavity 114 can be provided in an injection cavity block 120. A feature cavity 116 is provided to mold the desired feature into the preform.

The neck split 78 can be comprised of two portions or halves 124, 128 which are held in place by positioning the ends 132, 136 in an opening formed in the injection block 82 by sidewalls 140. A carrier 150 is provided to engage the neck split 78 for purposes of moving the neck split 78 and preform to another station. Tabs 154 can be provided on the neck split 78 for engaging a surface 158 of the carrier 150.

The injection core 74 can include a housing 160 having a lower end 164 that is dimensioned to fit into a corresponding opening in the neck split 78. An injection core mold surface 168 extends from the lower end 164. The injection core mold surface 168 is inserted into the mold cavity 114 of the injection cavity block 122 to form an interior wall of the preform.

The injection core 74 can also include structure for cooling the preform after it has been molded. Such cooling structure can be in many forms and as shown can include a cooling water inlet or bubbler 172 and water outlets 176. The bubbler 172 directs water into the lower end 164 of the injection core 74 so as to cool the injection core mold surface 168. This will cool the preform that has been molded and is in contact with the mold surface 168.

The creation of an opening in an end feature formed in the preform injection molding process requires that no plastic material can flow into the space where the opening is to be created. An injection cavity pin 180 can be provided for this purpose. The injection cavity pin 180 communicates with the feature cavity 116 and is insertable into the feature cavity 116 and retractable from the feature cavity 116 so as to permit the removal of the preform after the injection molding has been completed. The injection cavity pin 180 can be mounted to suitable structure such as a pneumatic, hydraulic or electric drive cylinder 184. The cylinder 184 is operable to move the injection cavity pin 180 into and out of the feature cavity 116.

The process of making a preform 200 is illustrated in FIGS. 4 A-D. The injection core 74 is inserted into the neck split 78 and the injection block 82, as shown in FIG. 4A. The injection core mold surface 168 is positioned in the mold cavity 114. The cylinder 184 is operated to move the injection cavity pin into the feature cavity 116.

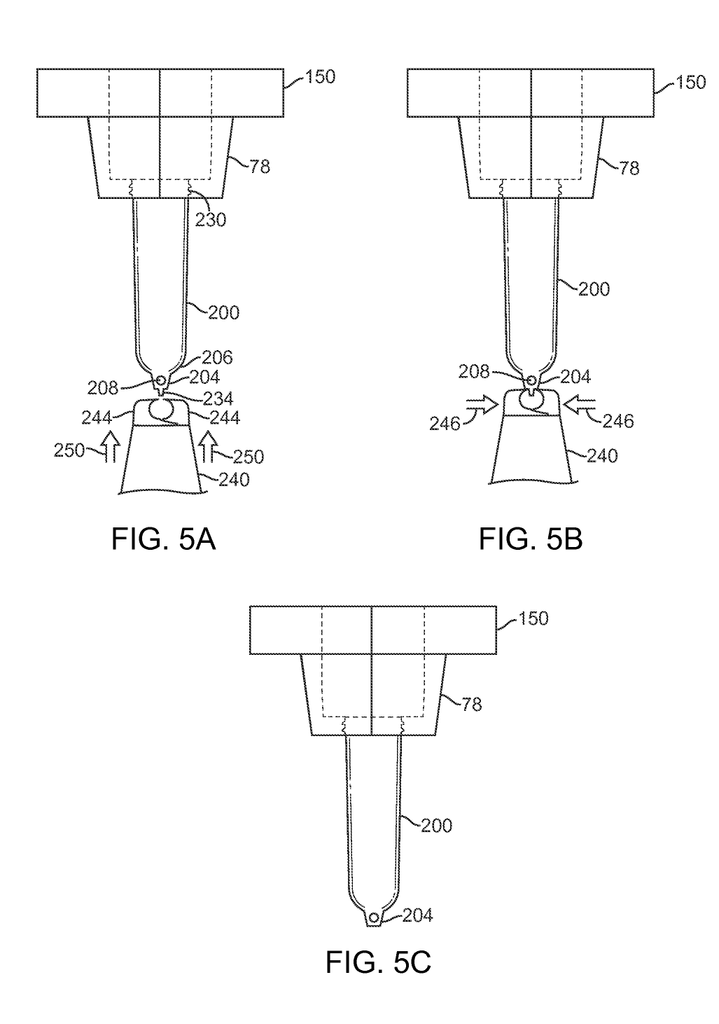

Plastic precursor material 204 is then conducted from a source (not shown) into the fluid conduit 94. The plastic material travels in the conduit 94 through the first nozzle 98, second nozzle 102 and third nozzle 104 into the feature cavity 116 and mold cavity 114, as shown in FIG. 4B. The preform 200 with end feature 204 at end 206 is formed in the mold cavity 114 and feature cavity 116. The presence of the injection cavity pin 180 in the feature cavity 116 creates a void space 208 in the feature 204 (FIG. 5A).

The injection cavity pin 180 is then removed from the feature cavity 116 by operation of the drive mechanism such as cylinder 184, as shown in FIG. 4C. The preform 200 can then be removed from the apparatus. Removal of the preform 200 from the preform molding apparatus 70 is shown in FIG. 4D. The injection core 74 is withdrawn from the neck split 78 as shown by the arrows 220. The neck split 78 is withdrawn from the injection block 82 as indicated by the arrows to 224. The neck split 78 engages preform 200 such that removal of the neck split 78 removes the preform 200. The engagement can be by any suitable structure. In the embodiment shown, the neck split 78 and preform 200 have cooperating threads 230 by which the neck split can engage the preform 200, and the preform 200 can be removed by unthreading the preform from the neck split 78. Other engagement structure is possible.

The preform 200 can then be moved to another station. The carrier 150 engages the neck split 78 and thereby the preform 200. The carrier 150 is movable by suitable mechanical apparatus. The carrier 150, neck split 78 and preform 200 can be moved to a gate cut station. The injection molding process typically forms a protrusive runner or gate 234 from excess plastic material filling the inlet opening to the mold cavity. These gates or runners are trimmed off to form the final part. A gate cutting operation is shown in FIGS. 5 A-C. The carrier 150 positions the neck split 78 and preform 200 over a gate cutter 240, as shown in FIG. 5A. The gate cutter 240 has suitable structure such as opposing jaws 244 which are operable to move toward and away from each other in a cutting operation. The gate cutter 240 can be raised as shown by the arrows to 250. The gate 234 is positioned between the jaws 244 as shown in FIG. 5B. The gate cutter 240 is operated to close the jaws 244 as shown by arrows 246 and to thereby remove the gate 234, as shown in FIG. 5C. The gate cutter 240 can be operated by any suitable means including pneumatic or hydraulic pressure or mechanical or electrical motors. Other gate cutting apparatus and methods are possible.

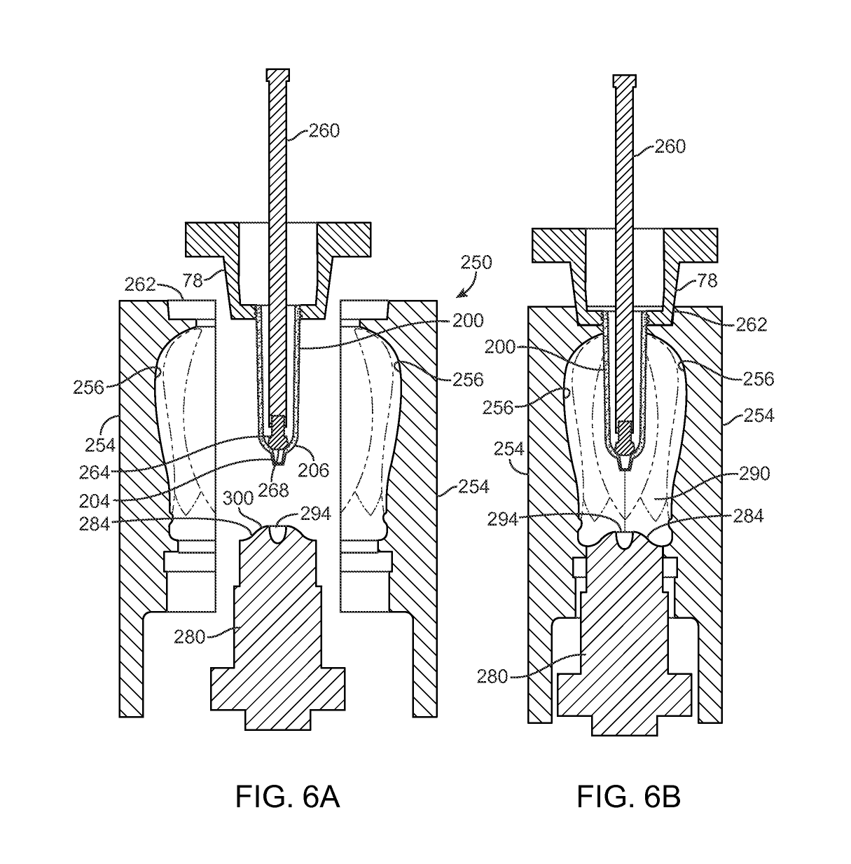

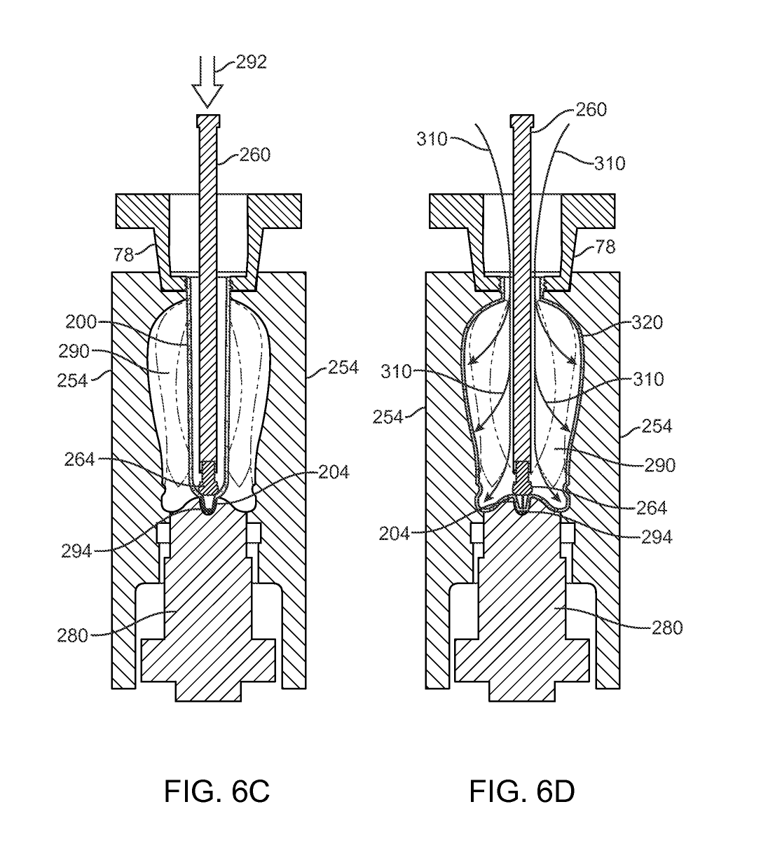

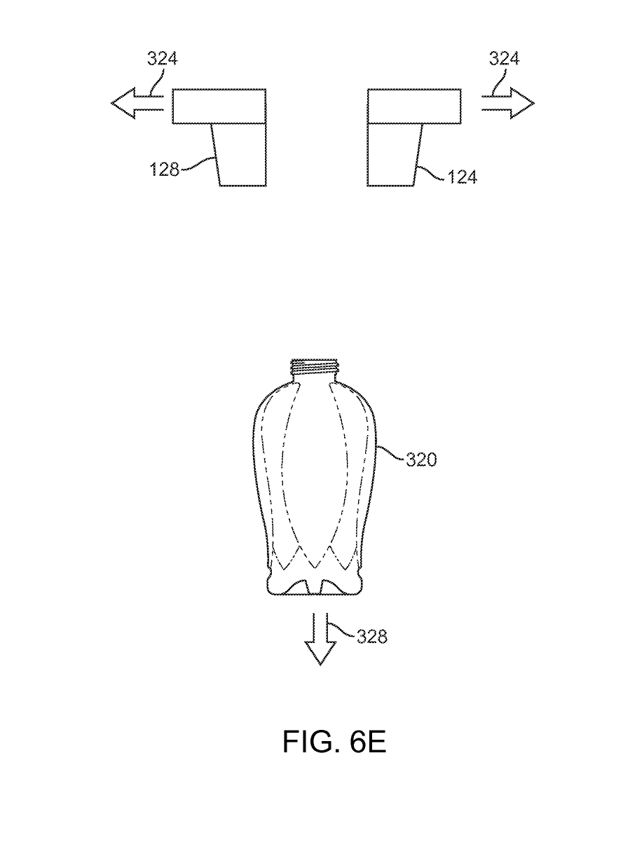

The preform 200 is then moved to a blow molding station. A blow molding process is illustrated in FIGS. 6 A-E. The preform 200 is positioned by movement of the neck split 78 to a position over the blow mold 250, as shown in FIG. 6A. The blow mold 250 can include first and second block mold sections 254. The mold sections 254 define an interior cavity with walls 256 forming the mold cavity. The block mold sections 254 are separated by a suitable mechanical drive mechanism (not shown). An elongated stretch rod 260 is inserted into the open interior cavity of the preform 200. The stretch rod 260 can have any suitable shape, diameter, or design. In the embodiment shown, the stretch rod 260 includes a tip 264. The tip 264 has a distal surface 268. The stretch rod 260 is inserted into the preform 200 such that the distal surface 268 abuts the end portion 206 of the preform 200, and is adjacent the end feature 204. A push-up 280 is provided and has a surface 284 which forms the bottom part of the mold cavity.

A feature cavity 294 is provided to form the desired feature into the preform during the injection molding process. The feature cavity 294 can be provided to fashion the feature at what will become the end 206 of the preform 200. The feature could alternatively or also be formed elsewhere on the preform 200. The feature cavity 294 will be filled with plastic material and so the feature so formed will take the shape of the feature cavity 294. The feature cavity 294 can take many different sizes, shapes and designs to impart these sizes, shapes and designs to the feature. The feature so formed can be much thicker in dimension than other portions of the preform 200 such as the side walls. This is desirable because it will in some instances be necessary that the feature have structural strength, such as when the feature is a hook that is intended for hanging the finished container, or could have a design that can be formed by injection molding but cannot be formed or is difficult to form by blow molding.

The mold 250 is then closed around the preform 200, as shown in FIG. 6B. The mold sections 254 are closed and mate with the push-up 280 such that the mold surfaces 256 and surface 284 define a mold cavity 290. The neck split 78 is lowered and mates with a receiving groove 262.

The stretch rod 260 is then operated by suitable driver (not shown) to move into the mold cavity 290 in the direction shown by arrow 292, as shown in FIG. 6C. The preform 200 is stretched and elongated by the movement of the stretch rod 260. The end feature 204 is pushed and/or retained by the stretch rod to 260 into the feature cavity 294. The tip 264 is positioned adjacent the end feature 204 and abuts the end portion 206 of the preform 200. It is important that the tip 264 does not make contact with the surface 284 as this will impact the plastic preform material from this section of the mold and result in a defective container. The tip 264 should move to a position abutting the end 206 of the preform 200 and adjacent a rim portion 300 that surrounds the feature cavity 294. The distance between the tip 264 and the rim 300 should be no less than the desired thickness of this portion of the finished container.

The blow molding operation commences with the injection of pressurized air or other gas as indicated by arrows 310, as shown in FIG. 6D. The pressurized air forces the preform 200 outward into contact with the walls 256 of the mold cavity 290 resulting in a finished container 320. The tip 264 of the stretch rod 260 retained the end feature 204 in position in the feature cavity 294. The end feature 204 is unaffected by the blow molding process and retains the same shape as it had before the blow molding process began. The tip 264 of the stretch rod 260 substantially shields the end feature 204 from the high pressure gas 310.

The finished container 320 is then removed from the mold. The mold sections 254 are separated and the neck split 78 is raised to remove the container 320. The sections 124, 128 of the neck split 78 are moved in the direction of arrows 324 to release the container 320 which can fall in the direction of arrow 328 into inappropriate collection apparatus for movement to further processing such as decoration or labeling.

The process of the invention can be controlled by a suitable controller, computer or processor of some kind. Such computer and programmable logic control systems are commonly used in the container manufacturing industry. The systems can control the various components such as injection mold, blow mold, gate cutter, and conveyance systems for conveying the preforms and containers through the manufacturing process and ultimately to packaging, storage and distribution.

It should be understood that the embodiments and examples described herein are for illustrative purposes and that various modifications or changes in light thereof will be suggested thereby and are to be included within the spirit and purview of this application. The invention can take other specific forms without departing from the spirit or essential attributes thereof.

We claim:

1. A method of making a container, comprising the steps of:
providing a preform having a body defining an interior cavity, the body having an end portion and an end feature protruding from the end portion;
placing the preform into a mold, the mold having a mold cavity for receiving the preform body and a feature cavity for receiving the end feature;
inserting a stretch rod into the interior cavity of the preform to a position adjacent the end feature, whereby the stretch rod will retain the end feature in the feature cavity;
blow molding the preform into a finished product, the stretch rod retaining the end feature in the feature cavity during the blow molding step.

2. The method of claim 1, wherein the mold comprises a rim about the feature cavity, the stretch rod being extended to a position abutting a portion of the preform between the stretch rod and the rim to retain the feature in the feature cavity during the blow molding step.

3. The method of claim 1, wherein the stretch rod and the mold define an annular gap for receiving a corresponding portion of the preform.

4. The method of claim 1, wherein the stretch rod is extended to a position no closer to the mold than the thickness of the preform between the stretch rod and the mold.

5. The method of claim 1, wherein the end feature remains unchanged during the blow molding step.

6. The method of claim 1, wherein the providing step includes molding the preform.

7. The method of claim 1, wherein molding the preform includes forming an opening in the end feature.

8. The method of claim 1, wherein the forming of an opening comprises inserting a pin during the molding of the preform to form the opening, and removing pin prior to removal of preform from preform mold.

9. The method of claim 8, wherein the preform is molded by an injection molding process.

10. An apparatus for making a container from a preform having an end feature, comprising:
a blow mold, the blow mold defining a main mold cavity and a feature cavity;
a stretch rod for inserting into the main mold cavity to a position adjacent the feature cavity, whereby the stretch rod will retain the end feature of the preform in the feature cavity during a blow molding step.

11. The apparatus of claim 10, wherein the stretch rod has a retracted position and an extended position, the stretch rod in the extended position extending into the mold cavity to a position where a tip portion of the stretch rod is adjacent the feature cavity, and a retracted position where the stretch rod is withdrawn from the mold cavity.

12. An apparatus for making a preform, comprising:
an injection mold having a body mold portion for molding a preform having an end portion; and,
an end feature mold portion for molding an end feature of the preform at an end portion.

13. The apparatus of claim 12, further comprising an injection cavity pin for forming an opening in the end feature during the molding of the end feature.

14. The apparatus of claim 13, further comprising a drive mechanism for extending and retracting the pin.

15. A preform for making a plastic container, comprising:
a preform body having an end portion;
an end feature at the end portion, the end feature protruding from the end portion.

16. The preform of claim 8, wherein the end feature comprises at least one opening.

17. A system for forming a container, comprising:
an apparatus for making a preform with an end feature, comprising an injection mold having a body mold portion for molding a preform body portion having an end portion; and, an end feature mold portion for molding an end feature of the preform at an end portion; and,
an apparatus for making a container from the preform having an end feature, comprising a blow mold, the blow mold defining a main mold cavity and a feature cavity, and a stretch rod for inserting into the main mold cavity to a position adjacent the feature cavity, whereby the stretch rod will retain the end feature of the preform in the feature cavity during a blow molding step.
